(19) United States
(12) Patent Application Publication
(10) Pub. No.: US 2008/0215825 A1
(43) Pub. Date: Sep. 4, 2008

(54) Memory Share by a Plurality of Processors

(75) Inventor: Kyung-chul Min, Seoul (KR)

Correspondence Address: HUSCH BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/917,885

(22) PCT Filed: Jun. 13, 2006
(86) PCT No.: PCT/KR2006/002249

§ 371 Date: Dec. 17, 2007

(30) Foreign Application Priority Data
Jun. 23, 2005 (KR) 10-2005-0054325

(51) Int. Cl. G06F 13/40

(52) U.S. Cl. 711/148; 711/E12.066

(57) ABSTRACT

A method and an apparatus for having a memory shared by a plurality of processors are disclosed. The digital processing apparatus in accordance with an embodiment of the present invention comprises a memory, a main processor connected to one side of the memory through a first memory bus, and application processors in a quantity of n connected parallel to the other side of the memory through a second memory bus. Each application processor performs at least one predetermined function. The main processor is connected parallel to the n application processors through a control bus, and delivers a control signal to at least one application processor through the control bus. With the present invention, the structure of a digital processing apparatus can be simplified, and the cost and size of a digital processing apparatus can be minimized.

### TECHNICAL FIELD

The present invention is directed to sharing of a memory (storage device), more specifically to a method and a device for having a memory shared by a plurality of processors in an electrical/electronic device (digital processing apparatus).

### BACKGROUND ART

As an example of electrical/electronic devices, portable terminals refer to electronic devices that can be easily carried by making the size compact in order to perform functions such as game and mobile communication. Portable terminals include mobile communication terminals, personal digital assistants (PDA), and portable multimedia players (PMP).

The mobile communication terminal is essentially a device designed to enable a mobile user to telecommunicate with a receiver who is remotely located. Thanks to scientific development, however, the latest mobile communication terminals have functions, such as camera and multimedia data playback, in addition to the basic functions, such as voice communication, short message service, and address book.

FIG. 1 shows a block diagram of a conventional mobile communication terminal having a camera function.

Referring to FIG. 1, the mobile communication terminal 100 having a camera function comprises a high frequency processing unit 110, an analog-to-digital converter 115, a digital-to-analog converter 120, a control unit 125, a power supply 130, a key input 135, a main memory 140, a display 145, a camera 150, an image processing unit 155, and a support memory 160.

The high frequency processing unit 110 processes a high frequency signal, which is transmitted or received through an antenna.

The analog-to-digital converter 115 converts an analog signal, outputted from the high frequency processing unit 110, to a digital signal and sends to the control unit 125.

The digital-to-analog converter 120 converts a digital signal, outputted from the control unit 125, to an analog signal and sends to the high frequency processing unit 110.

The control unit 125 controls the general operation of the mobile communication terminal 100. The control unit 125 can comprise a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends to the control unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100, relevant information (e.g. date and time) and an external image photographed by the camera 150.

The camera 150 photographs an external image (a photographic subject), and the image processing unit 155 processes the external image photographed by the camera 150. The image processing unit 155 can perform functions such as color interpolation, gamma correction, image quality correction, and JPEG encoding. The support memory 160 stores the external image processed by the image processing unit 155. The support memory 160 can be an SRAM (Static RAM) or an SDRAM (Synchronous DRAM).

As described above, the mobile communication terminal 100 having a camera function is equipped with a plurality of processors (that is, a main processor and one or more application processors for performing additional functions). In other words, as shown in FIG. 1, the control unit 125 for controlling general functions of the mobile communication terminal 100 and the image processing unit 155 for controlling the camera function are included. Moreover, each processor is structured to be coupled with an independent memory. When a digital processing apparatus, such as the mobile communication terminal 100, has a plurality of processors, the application processor for performing an additional function can be controlled by the main processor.

The application processor can take different forms and quantity depending on the kinds of additional functions, with which the portable terminal is equipped. For example, the application processor for controlling the camera function can process functions such as JPEG encoding and JPEG decoding; the application processor for controlling the movie file playback function can process functions such as video file (e.g., MPEG4, DIVX, H.264) encoding and decoding; and the application processor for controlling the music file playback function can process functions such as audio file encoding and decoding. The portable terminal can also comprise an application processor for controlling games. Each of these control units has an individual memory for storing the processed data.

In an arrangement as this, various attempts are being made to have the memory in each application processor shared by another application processor or the main processor, in order to expand the storage space or improve the process efficiency. In this case, a bus controller or a selector is used to classify a processor (i.e. the main processor or any of the application processors) that can use a particular memory.

FIGS. 2-4 show conventional memory sharing structures.

Referring to FIG. 2, a plurality of application processors 210, 220, and 230 are connected to a bus controller 250 of the main processor 240 and to a plurality of supplementary memories 260, 270, and 280 through each bus. Each supplementary memory can be a memory that is subordinate to each application processor. Of course, the main processor 240 can comprise a main memory (not illustrated), which is subordinate to the main processor and can have data written by another application processor.

Generally, in order for each application processor to write data in a supplementary memory belonging to the application processor or another application processor, each application processor must be connected to each supplementary memory while encompassing a bus controller (not illustrated) in the pertinent application processor.

In this case, it must be known which supplementary memory is currently used by each application processor, and moreover, since there is a possibility of buses colliding or data being written redundantly by a plurality of application processors in the same storage area of a supplementary memory, the main processor 240 must encompass a separate controller 250 in order to control this possibility. In other words, the bus controller 250 disposed in the main processor 240 manages the access status of the supplementary memory in each application processor to prevent the collision of buses or the redundant writing of data.

However, in the memory sharing structure illustrated in FIG. 2, the structure of the main processor 240 becomes complicated, and the main processor 240 loses the process efficiency of its main features. Besides, the overall system becomes more dependent on the main processor 240. This is due to the need by the bus controller 250 in the main processor 240 to perform other functions such as bus control.

Referring to FIG. 3, each of the plurality of application processors 210 and 220 is connected to the main processor 240 and a plurality of memories 260, 270, and 310 through each bus. Each supplementary memory can be a memory that is subordinate to each application processor.

In order for a plurality of processors to share a plurality of memories, each processor (i.e. the main processor or the application processor) has to be bus-controlled by the main processor 240 while being interfaced with each memory. In other words, the main processor 240 must further have control logic for controlling the application processor as well as the bus controller. Under this condition, the main processor 240 terminates the pertinent application processor or disables the pertinent application processor such that a particular memory cannot be used by an application processor.

However, in the memory sharing structure illustrated in FIG. 3 also, the structure of the main processor 240 becomes complicated, and the main processor 240 loses the process efficiency of its main features. Besides, the overall system becomes more dependent on the main processor 240. This is due to the need by the bus controller 250 in the main processor 240 to perform other functions such as bus control.

FIG. 4 shows a structure of a plurality of processors (i.e. the main processor 240 and a plurality of application processors 210 and 220) sharing one shared memory 410. In the memory sharing structure shown in FIG. 4 also, like the memory sharing structure of FIG. 3, each processor (i.e. each of the main processor and application processors) must be interfaced with the shared memory 410 and bus-controlled by the main processor 240. That is, the main processor 240 must further have control logic for controlling the application processor as well as the bus controller.

Therefore, the main processor 240 still has the problems of complicated structure and low process efficiency even with the memory sharing structure of FIG. 4.

For a portable terminal, however, the size is as important as its performance. If a processor and a memory have a one-to-one match, or the processors and memories have an n-to-n match, as described above, it becomes inevitable that the external size of the portable terminal increases due to the increased number of components and the complexity of structure. Moreover, the production cost for the processor increases because processors need to be added to meet the complex structure.

### DISCLOSURE

### Technical Problem

Therefore, in order to solve the above problems, the present invention aims to provide a method and a device for having a memory shared by a plurality of processors that can use a simple structure of main processor to control a plurality of application processors.

Another object of the present invention is to provide a method and a device for having a memory shared by a plurality of processors that can save time taken to process data, by allowing the main processor and the application processor to access a memory simultaneously.

It is yet another object of the present invention to provide a method and a device for having a memory shared by a plurality of processors that can minimize the cost and size of a portable terminal, by allowing a memory shared by a plurality of processors without having to provide a separate memory for each processor.

Other objects of the present invention will become apparent through preferred embodiments described below.

### Technical Solution

In order to achieve the above objects, an aspect of the present invention features a digital processing apparatus having a plurality of processors.

According to a preferred embodiment of the present invention, the digital processing apparatus having a memory sharing structure comprises: a memory; a main processor, being connected to one side of the memory through a first memory bus; and application processors in a quantity of n (an integer), being connected parallel to the other side of the memory through a second memory bus, each application processor performing at least one predetermined function. Here, the main processor is connected parallel to the n application processors through a control bus, and the main processor delivers a control signal to at least one of the application processors through the control bus.

The above control signal can comprise a control command for a process operation to be performed by one application processor selected from the n application processors, and can be delivered to the selected application processor through the control bus. The control signal can further comprise at least one from a group consisting of information for selection of one application processor and storage location information of data corresponding to the process operation.

The above second memory bus is occupied by, among the n application processors, one application processor only, corresponding to the selection information, during the same time period.

The above application processor can release the occupation of the second memory bus if the process operation corresponding to the control command is completed or a command to release bus occupation is received from the main processor through the control bus.

The application processor, which received the control signal, can send a completion response to the main processor through the control bus after completing the process operation corresponding to the control signal.

The above memory is characterized by consisting of two or more ports.

The memory and the main processor can be disposed in the same chip, and the first memory bus can be an internal bus.

In order to achieve the above objects, another aspect of the present invention features a method for having a memory shared by a plurality of processors in a digital processing apparatus.

According to a preferred embodiment of the present invention, the method for having a memory shared by a plurality of processors comprises: a main processor writing data in a storage area of a memory accessed through a first memory bus; the main processor selecting an application processor to deliver a control signal comprising a control command for a process operation to be performed by an application processor using the data; delivering a control signal comprising the control command to the selected application processor through a control bus; and the application processor reading the data from the memory accessed through a second memory bus in accordance with the control signal and processing the data in accordance with the control command. Here, n application processors are connected parallel to one side of the memory through the second memory bus; and the main processor is connected to the other side of the memory through the first memory bus, is connected parallel to the n application processors through the control bus, and delivers a control signal to at least one of the application processors through the control bus.

The above control signal can further comprise at least one from a group consisting of information for selection of one application processor and storage location information of data corresponding to the process operation.

The above second memory bus can be occupied by, among the n application processors, one application processor only, corresponding to the selection information, during the same time period.

The method can further comprise the step of the application processor, which received the control signal, sending a completion response to the main processor through the control bus after completing the process operation corresponding to the control signal.

The method can further comprise the step of the application processor releasing the occupation of the second memory bus if the process operation corresponding to the control command is completed or a command to release bus occupation is received from the main processor through the control bus.

### DESCRIPTION OF DRAWINGS

FIG. 1 shows a block diagram of a conventional mobile communication terminal having a camera function;

FIGS. 2-4 show conventional memory sharing structures;

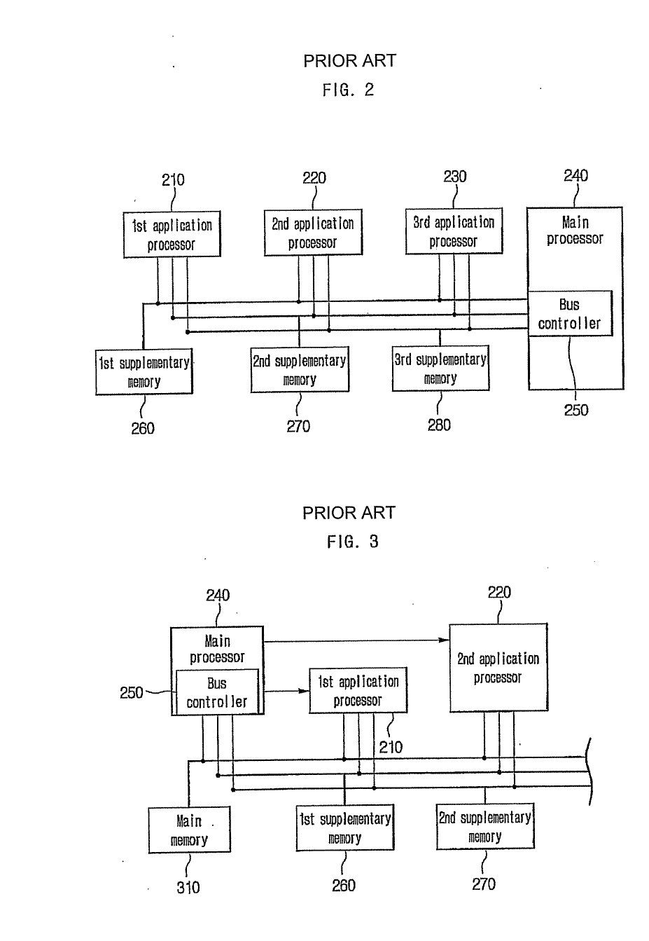

FIG. 5 shows a block diagram of a memory sharing structure in accordance with a preferred embodiment of the present invention;

FIG. 6 shows a flowchart of a main processor delivering data to a particular application processor, in accordance with a preferred embodiment of the present invention; and

FIG. 7 shows a flowchart of the main processor receiving data from the particular application processor, in accordance with a preferred embodiment of the present invention.

### MODE FOR INVENTION

The above objects, features, and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents, and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to the other element, it shall be construed as being connected or accessed to the other element directly but also as possibly having another element in between. On the other hand, if one element is described as being “directly connected” or “directly accessed” to the other element, it shall be construed that there is no other element in between.

The terms used in the description are intended to describe certain embodiments only, and shall by no means restrict the present invention. Unless clearly used otherwise, expressions in the singular include pluralized expressions. In the present description, an expression such as “comprising” or “consisting of” is intended to designate a characteristic, a number, a step, an operation, an element, a part, or combinations thereof, and shall not be construed to preclude any presence or possibility of one or more other characteristics, numbers, steps, operations, elements, parts, or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

Although it is evident that the method for sharing a memory in accordance with the present invention can be equivalently applied to all types of digital processing devices or systems (e.g. portable terminals and/or home digital appliances, such as the mobile communication terminal, PDA, portable multimedia player (PMP), MP3 player, digital camera, digital television, audio equipment, etc.), the portable terminal will be described hereinafter for the convenience of description and understanding. Moreover, it shall be easily understood through the below description that the present invention is not limited to a specific type of terminal but is applicable equivalently to any terminal having a plurality of processors and a shared memory.

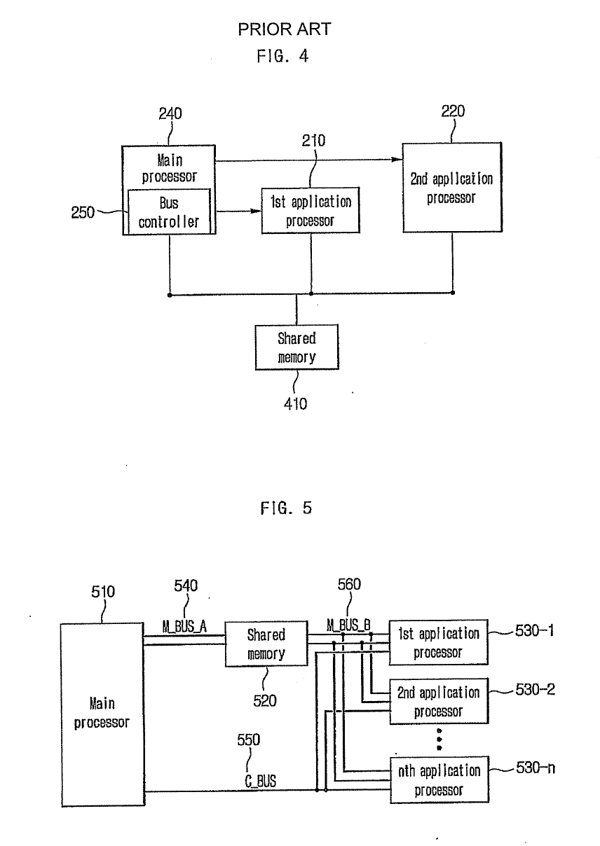

FIG. 5 is a block diagram showing a memory sharing structure in accordance with a preferred embodiment of the present invention.

As shown in FIG. 5, the portable terminal having a memory sharing structure comprises a main processor 510, a shared memory 520, and n application processors 530-1, 530-2, . . . , and 530-n (collectively 530, hereinafter).

The main processor 510 can be a processor that can control the overall operation of the portable terminal and give a control command (e.g. to start an operation, to stop an operation, and to operate a process) to each application processor. Although not shown in FIG. 5, the main processor 510 can be coupled to a separate main memory or comprise a main memory. Of course, it is possible, as necessary, that each application processor or a particular application processor is coupled to an independent supplementary memory or comprises a supplementary memory.

The main processor 510 is connected to the shared memory 520 through a first memory bus (M_BUS_A) 540, and to the plurality of application processors 530 through a control bus (C_BUS) 550. The main processor 510 writes data in the shared memory 520 or reads data from the shared memory 520 through the first memory bus 540. The main processor 510 delivers a control command (e.g. a command to start an operation, a command to stop an operation, an instruction to operate a process, an instruction to read, and an instruction to write) to each application processor 530 through the control bus 550.

The shared memory is realized as a dual-port type, which is capable of being operated (i.e. read or write) by a plurality of processors that are accessed at the same time. By using a dual-port memory, while one processor is accessing the shared memory 520, the waiting time of other processors becomes shorter, saving the data processing time. Of course, the number of ports that the shared memory 520 has can vary as necessary.

The shared memory 520 is connected to the main processor 510 through the first memory bus 540 and is connected to the plurality of application processors 530 through independent second memory buses (M_BUS_B) 560. The plurality of application processors 530 are connected to the shared memory 520 by being coupled parallel with the second memory buses 560.

Each of the application processors 530 can be a processor dedicated to process any of the functions, including MPEG4, 3-D graphic, camera, and game control, or a processor to perform a combination of the functions. The number of application processors 530 in a portable terminal can vary according to the types of functions the portable terminal has.

Each application processor 530 is connected to the shared memory 520 through the second memory bus 560, and to the main processor 510 through the control bus 550. A particular application processor 530 that received a control command (e.g. a command to start an operation, a command to stop an operation, an instruction to operate a process, an instruction to read, and an instruction to write) through a control bus 550 from the main processor 510 accesses the shared memory 520 through the second memory bus 560 and then performs an operation (e.g. writing data or reading data) corresponding to the control command. The control command delivered from the main processor 510 can be, for example, a command to read specific data from the shared memory 520 and process the data in the corresponding application processor 530 then to store the processed data in the shared memory 520.

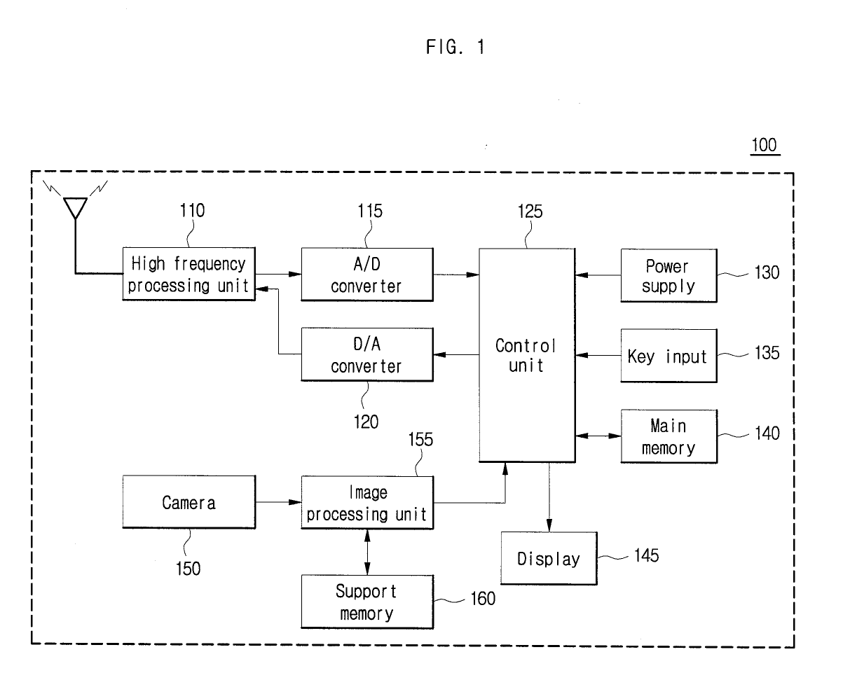

Hereinafter, the operation process of the present invention will be briefly described with reference to the memory sharing structure illustrated in FIG. 1.

The portable terminal comprises one main processor 510 and a plurality of application processors 530. The main processor 510 controls the operation of each application processor 530 by delivering a control command, which provides an instruction of certain operation, to each application processor 530. Each application processor 530 can be any of a group consisting of, for example, a camera control processor, an audio processor, a game controller, an image processor, a multimedia data processing processor, a communication processor, a processor processing data detected by a sensor, and a processor performing a supplementary function such as an infrared pointer.

The main processor 510 is connected to the shared memory 520 through the first memory bus 540, and the plurality of application processors 530 are connected parallel to the shared memory 520 through the second memory buses 560. Since the shared memory 520 is a dual-port type, one of the application processors 530 can access the shared memory while the main processor 510 is accessed to the shared memory 520. However, since the plurality of application processors 530 are commonly connected to one memory port, it may be necessary that the main processor 510 deliver selection information to a particular application processor 530 that needs to access the shared memory 520. The application processor 530 that receives the selection information from the main processor 510 performs the operation corresponding to the control command delivered with the selection information. Of course, the selection information does not have to be delivered if the main processor 510 selects an application processor 530, to which a control command is to be delivered, and sends the control command to the application processor 530.

The memory sharing structure between a plurality of processors, in accordance with a preferred embodiment of the present invention, has been described heretofore with reference to FIG. 5. In the description, the memory shared by a plurality of processors has been described to exist independently (i.e. an external memory).

However, another preferred embodiment of the present invention can provide a memory sharing structure in which a memory (i.e. an internal memory) included in a chip having the main processor 510 is shared by a plurality of processors (i.e. the main processor 510 and application processors 530).

In this case, the main processor 510 is connected to the shared memory 520 in the same chip through an internal bus, and is connected parallel to the plurality of application processors 530 through the control bus 550. The shared memory 520 is connected parallel to the plurality of application processors 530 through external data buses (i.e. the second memory buses 560).

In other words, when the shared memory 520 placed in the same chip as the main processor 510 is shared by a plurality of processors, the location of the shared memory 520 is only different, and the operational process can be identical to the above description.

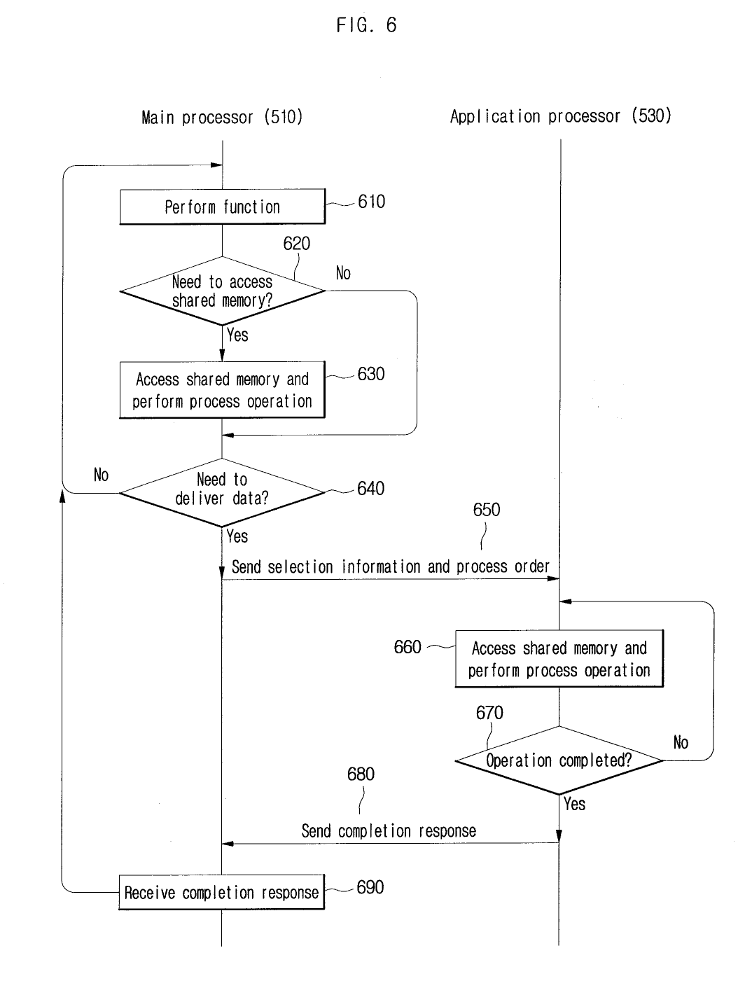

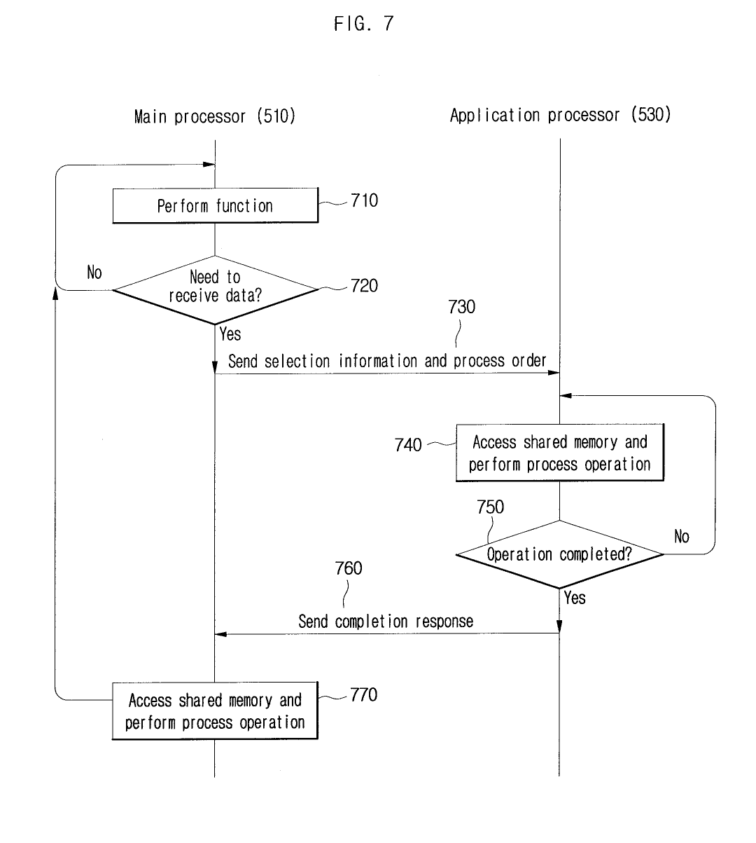

FIG. 6 is a flowchart showing the main processor 510 delivering data to a particular application processor 530, in accordance with a preferred embodiment of the present invention, and FIG. 7 is a flowchart showing the main processor 510 receiving data from the particular application processor 530, in accordance with a preferred embodiment of the present invention.

Although the process of delivering and receiving data between the main processor 510 and the particular application processor 530 can be performed consecutively, sequentially, successively, or alternately, FIG. 6 and FIG. 7 will be independently described here for the convenience of understanding.

Described first herein with reference to FIG. 6 is the process of the main processor 510 transmitting stored data to an application processor 530.

In step 610, the main processor 510 performs a function (e.g. processing data, controlling an application processor, etc.) among a variety of predetermined functions.

In step 620, the main processor 510 determines whether the shared memory needs to be accessed in order to write data. Of course, step 620 can be a step for determining whether the main processor 510 needs to access the shared memory 520 in order to read the data written in the shared memory 520.

If the shared memory 520 needs to be accessed, step 630 is performed such that the main processor 510 accesses the shared memory 520 through the first memory bus (M_BUS_A) 540 and then performs the process operation (e.g. writing data) needed for performing the corresponding function. In case the process operation of step 630 is reading data, the corresponding data can be the data that has been stored by an application processor 530 in accordance with a control signal delivered from the main processor 510.

In step 640, the main processor 510 determines whether the data written in the shared memory 520 needs to be delivered to a particular application processor 530. The data stored in the shared memory 520 can be the data stored by the main processor 510 in steps 610-630 or the data stored by another application processor 530 (refer to steps 660-670).

If the data needs to be delivered, the main processor 510 selects an application processor, to which the data needs to be delivered, and delivers a corresponding control signal, in step 650, to the corresponding application processor 530 through the control bus (C_BUS) 550. The control signal can comprise corresponding selection information and a process order (e.g. a control command for at least one of the operations consisting of reading data, processing data, and storing the processed data). Of course, the selection information does not have to be delivered if the main processor 510 selects an application processor 530, to which a process order (control command) is to be delivered, and selectively sends the process order to the application processor 530 only. Moreover, in case the process order comprises storing data, the control signal can further comprise information on the location to store the data.

In step 660, the application processor 530, which received the control signal from the main processor 510 through the control bus 550, accesses the shared memory 520 through the second memory bus (M_BUS_B) 560 in order to carry out the process order included in the control signal, and then performs the corresponding process operation. The process operation by the application processor 530 corresponds to the process order, and can comprise at least one of the operations consisting of reading data, processing data, and storing the processed data.

In step 670, the application processor 530 determines whether the process operation corresponding to the process order is completed. If the process operation is not completed, step 660 is performed; if the process operation is completed, step 680 is performed.

In step 680, the application processor 530 sends a completion response, indicating that the process operation corresponding to the process order is completed, to the main processor 510 through the control bus 550. If the control signal, received from the main processor 510, does not comprise information on storage location of data, the completion response can comprise the information on storage location of stored data. The occupation of the second memory bus 560 by the application processor 530 becomes released due to the control signal, corresponding to the operation completion order of the main processor 510, or a series of follow-up operations, caused by the transmission of the completion response. Hence, it becomes possible for another application processor 530 selected by the main processor 510 to occupy the second memory bus 560.

If the completion response is received from the application processor 530 in step 690, the main processor 510 proceeds to step 610 again to perform follow-up operations.

Now, the process of the main processor 510 ordering an application processor 530 to store data in the shared memory 520 and then reading the data stored by the application processor 530 will be described with reference to FIG. 7.

In step 710, the main processor 510 performs a function (e.g. processing data, controlling an application processor, etc.) among a variety of predetermined functions.

In step 720, the main processor 510 determines whether the data to be processed by performing the function needs to be received from an application processor 530. Of course, step 720 will be carried out if the main processor 510 accesses the shared memory 520 through the first memory bus 540 to recognize the absence of data to process or refers to the completion response received from the application processor 530 through the control bus 550 to recognize the absence of the corresponding data in the shared memory. In other words, if the data to be processed by the main processor 510 already exists in the shared memory, reading and processing the pertinent data will be sufficient, thereby eliminating the need to perform steps 720 through 760.

If data needs to be provided, the main processor 510 selects an application processor 530 that will provide the data and delivers the corresponding control signal to the corresponding application processor 530 through the control bus 550, in step 730. The control signal can comprise the corresponding selection information and process order (e.g. control command for one of the reading data, processing data, and storing the processed data). Of course, if the main processor 510 selects an application processor 530, to which the process order (control command) will be delivered, and then selectively sends the process order to the pertinent application processor 530 only, the selection information does not have to be sent. Moreover, in case the process order includes storing of data, the pertinent control signal can further comprise the location information in which the data is to be stored.

The application processor 530, which received the control signal from the main processor 510 through the control bus 550, accesses the shared memory 520, in step 740, through the second memory bus (M_BUS_B) 560 in order to carry out the process order included in the control signal and then carries out the corresponding process operation. The process operation by the application processor 530 corresponds to the process order and can comprise at least one of the operations consisting of, for example, reading data, processing data, and storing the processed data.

In step 750, the application processor 530 determines whether the process operation corresponding to the process order is completed. If the process operation is not completed, step 740 is performed; if completed, step 750 is performed.

In step 760, the application processor sends a completion response, indicating that the process operation corresponding to the process order is completed, to the main processor 510 through the control bus 550. If the control signal, received from the main processor 510, does not have location information of the data, the completion response can comprise storage location information of the stored data. The occupation of the second memory bus 560 by the application processor 530 becomes released due to the control signal, corresponding to the operation completion order of the main processor 510, or a series of follow-up operations, caused by the transmission of the completion response. Hence, it becomes possible for another application processor 530 selected by the main processor 510 to occupy the second memory bus 560.

If the completion response is received from the application processor 530 in step 770, the main processor 510 proceeds to step 710 again to perform follow-up operations. That is, the main processor 510 reads the data, stored in the shared memory 520 by the application processor 530, and carries out the corresponding function (e.g. at least one of the functions consisting of processing data and storing the processed data).

The drawings and detailed description are only examples of the present invention, serve only for describing the present invention, and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, the present invention can use a simple structure of main processor to control the operation of a plurality of application processors.

The present invention can also save time taken to process data, by allowing the main processor and the application processor to access a memory simultaneously.

Moreover, the present invention can minimize the cost and size of a portable terminal, by allowing a memory shared by a plurality of processors without having to provide a separate memory for each processor.

What is claimed is:

1. A digital processing apparatus having a memory sharing structure, the digital processing apparatus comprising:
a memory;
at least one application processor connected to said memory through a first memory bus, the at least one application processor performing predetermined function; and
a main processor connected to said memory through a second memory bus, the main processor being connected parallel to said at least one application processor through a control bus, the main processor delivering a control signal to at least one of said application processor through said control bus.

2. The digital processing apparatus of claim 1, wherein said control signal comprises a control command for a process operation to be performed by one application processor selected from said at least one application processor, and is delivered to said selected application processor through said control bus.

3. The digital processing apparatus of claim 2, wherein said control signal further comprises at least one from a group consisting of information for selection of one application processor and storage location information of data corresponding to said process operation.

4. The digital processing apparatus of claim 3, wherein said first memory bus is occupied by, among said at least one application processors, one application processor only, corresponding to said selection information, during the same time period.

5. The digital processing apparatus of claim 2, wherein said application processor releases the occupation of said second memory bus if the process operation corresponding to said control command is completed or a command to release bus occupation is received from said main processor through said control bus.

6. The digital processing apparatus of claim 1, wherein the application processor, which received said control signal, sends a signal indicating completion to said main processor through said control bus after completing the process operation corresponding to said control signal.

7. The digital processing apparatus of claim 1, wherein said memory comprises a plurality of ports.

8. The digital processing apparatus of claim 1, wherein said memory and said main processor are disposed in the same chip, and said second memory bus is an internal bus.

9. A method for having a memory shared by a plurality of processors, the method comprising:
writing data in a storage area of a memory with a main processor accessed through a first memory bus;
selecting an application processor to deliver a control signal with said main processor the control signal comprising a control command for a process operation to be performed by an application processor using said data;
delivering a control signal comprising said control command to said selected application processor through a control bus; and
reading said data from said memory with said application processor accessed through a second memory bus in accordance with said control signal and processing said data in accordance with said control command,
wherein at least one application processor are connected parallel to said memory through said second memory bus,
said main processor is connected to said memory through said first memory bus, is connected parallel to said at least one application processor through said control bus, and delivers a control signal to at least one of said application processor through said control bus.

10. The method of claim 9, wherein said control signal further comprises at least one from a group consisting of information for selection of one application processor and storage location information of data corresponding to said process operation.

11. The method of claim 10, wherein said second memory bus is occupied by, among said at least one application processor, one application processor only, corresponding to said selection information, during the same time period.

12. The method of claim 9, further comprising the step of the application processor, which received said control signal, sending a completion response to said main processor through said control bus after completing the process operation corresponding to said control signal.

13. The method of claim 9, further comprising the step of said application processor releasing the occupation of said second memory bus if the process operation corresponding to said control command is completed or a command to release bus occupation is received from said main processor through said control bus.

14. The digital processing apparatus of claim 1, wherein said main processor is connected to one side of said memory and said at least one application processor is connected to the other side of said memory.

15. The method of claim 9, wherein said main processor is connected to one side of said memory and said at least one application processor is connected to the other side of said memory.
